(19) United States
(12) Patent Application Publication
(10) Pub. No.: US 2002/0165843 A1
(43) Pub. Date: Nov. 7, 2002

(54) Legal reasoning analysis methodology and device

(76) Inventor: Tsunefumi Takahashi, Saitama (JP)

Correspondence Address: GREENBLUM & BERNSTEIN, P.L.C., 1941 ROLAND CLARKE PLACE, RESTON, VA, 20191, US

(21) Appl. No.: 10/022,501

(22) Filed: Dec. 20, 2001

(30) Foreign Application Priority Data
May 7, 2001 (JP) 2001-136201

(51) Int. Cl. G06N 5/02; G06F 17/00

(52) U.S. Cl. 706/47

(57) ABSTRACT

A method provides legal reasoning analysis for determining a law and includes presenting a legislative objective of the law via a computer network accessible by multiple participants, determining an initial law corresponding to the legislative objective, presenting an initial image that does not fit in with the initial law and potentially obstructs the legislative objective, and determining a second law by revising the initial law to remove the potential obstruction caused by the initial image that does not fit in. Presenting the image that does not fit includes presenting a proposed image that does not fit in via the computer network, receiving votes on whether the proposed image that does not fit obstructs the legislative objective, and presenting the proposed image that does not fit in as the initial image that does not fit in when a majority of the participants agree that it obstructs the legislative objective.

### BACKGROUND OF THE INVENTION

1. Field of the Invention

The present invention relates to the field of legal analysis, reasoning and decision making. More particularly, the present invention relates to a legal reasoning analysis methodology, a legal decision making device, a legal reasoning analysis voting system, a legal reasoning computer program and storage medium for storing the computer program, and a legal map created to depict the legal reasoning analysis.

2. Background of the Invention

Currently, legal reasoning and decision making, including legislating, interpreting and applying laws, are not based on any clear standard in regard to methodology. In reality, the pragmatic reasoning process underlying legal decisions is often obscured by idealistic concepts, such as freedom, fairness or natural law. The precise structure of the reasoning has been concealed, or in some cases, the decision-makers themselves do not realize exactly how logic was involved in reaching a particular conclusion.

Conventional methods for analyzing an economic decision making process provides an illustrative comparison to the legal decision making process. In particular, a decision tree diagram is well-known as the original form of the option pricing theory in economics. A decision tree diagram is essentially a tree trunk with many extending branches, as depicted in FIG. 18, which serves as a decision making tool for precisely measuring economic value, expected pay-off and relationships between the two. Typically, a branch is chosen (possible best selection) with the highest (net present value of) payoff, using probability and pseudo-probability of occurrence of the events and the predicted payoff at each stage of analysis. The decision tree diagram is likewise used to calculate the expected (net present) value of each branch by multiplying each branch's pseudo probability. The branch yielding the highest payoff potentially indicates the most desirable alternative to be chosen.

On one hand, the decision tree diagram includes branches with limited lengths. At some stage, a branch ends, i.e., the branch has not been extended to infinity. This is because there are limitations or constraints in estimating far end future events. If the payoff of every branch were to have a value of infinitely negative, there would be no possible alternative to be chosen. In other words, in every case, the situation would be catastrophic. On the other hand, when there is only one finite value alternative, and the other alternatives yield infinitely negative payoffs, the solution to be chosen is apparent, i.e., the branch yielding the finite payoff. From that standpoint, there is a certain unique, identifiable solution in some cases under certain specific situations or conditions. Legal decision making fits in such a specific situation.

While the economic decision making process is intended to maximize profit or present value of cash flow, the legal decision making process is intended to prevent totally destructive disasters from occurring. Both processes are analytical judgments based on decomposition and re-composition of future projections. The legal decision making process, however, is not intended to maximize expected value. Rather, the legal decision making process ideally indicates the approach to choosing the only alternative that does not result in unacceptable or disastrous consequences in applying a law. In that sense, the legal decision making process is a subset of the economic decision making process, assuming some special circumstances. In that sense, using a decision tree diagram or discounted cash flow analysis for legal decision-making is not adequate.

Furthermore, traditional legal reasoning is based on analysis by words, only. As a result, there are sometimes leaps in reasoning or sophistry that may not be apparent in a written (or verbal) description of the analysis. To counter such decisions is quite difficult due to the lack of a rational procedure, propagating the so-called “endless dispute.” Also, the focus of the discussion underlying the decision making process may not be easily understood by the affected parties, let alone by third parties who may attempt subsequent analysis of the decision.

### SUMMARY OF THE INVENTION

In view of the above, the present invention through one or more of its various aspects and/or embodiments is presented to accomplish one or more objectives and advantages, such at those noted below.

The first objective of the present invention is to present a legal decision making device and legal reasoning analysis methodology that clarifies the legal reasoning process. The second objective of the present invention is to present a voting system that further clarifies the result of the legal reasoning process, especially to a third party. The third objective of the present invention is to provide a computer program that conducts the legal reasoning analysis methodology in order to clarify the legal reasoning process. The fourth objective of the present invention is to present a method of creating a legal map that further clarifies the legal reasoning process.

An aspect of the present invention provides a method for analyzing legal reasoning for determining a law. The method includes presenting a legislative objective of the law through a computer network and determining an initial law corresponding to the legislative objective. An initial image that does not fit in with the initial law is presented by way of the computer network, potentially obstructing the legislative objective. A second law is determined by revising the initial law to remove the potential obstruction caused by the initial image that does not fit in with the initial law. The second law may also be presented through the computer network. A second image that does not fit in with at least one of the initial law and the second law, potentially obstructing the legislative objective, may also be presented. A third law may then be determined by revising the second law to remove the potential obstruction of the second image that does not fit in with the initial law or the second law.

Presenting the image that does not fit in may include presenting a proposed image that does not fit in through the computer network, which is accessible by multiple participants. Votes are received on whether the proposed image that does not fit in would actually obstruct the legislative objective. The proposed image that does not fit in is then presented as the initial image that does not fit in, regardless of whether the voting determines that a majority of the participants agree that the proposed image that does not fit in obstructs the legislative objective. At least a percentage of the participants that agree that the proposed image that does not fit obstructs the legislative objective may be displayed over the computer network, substantially simultaneously.

Another aspect of the present invention provides a method for creating a legal map depicting legal reasoning for determining a law. The method includes presenting an objective of the law, determining an initial law to represent the objective and depicting the initial law at a first position of a triangle. An image that does not fit in with the objective, as represented by the initial law, is presented and depicted at a second position of the triangle. A second law that addresses the image that does not fit in with the objective is derived and depicted at a third position of the triangle. The second law may also be depicted at a first position of a second triangle. A second image that does not fit in with the objective, as represented by the second law, is then presented and depicted at a second position of the second triangle. A third law that addresses the second image that does not fit in with the objective is derived and depicted at a third position of the second triangle.

Another aspect of the present invention provides a computer readable medium for storing a computer program that enables analysis of legal reasoning to derive a law relating to an objective. The computer readable medium includes a receiving source code segment, which receives the objective of the law and an initial law proposed to achieve the objective, and a presenting source code segment, which presents an image that does not fit in with the objective as indicated by the initial law. The receiving source code segment receives a second law, derived from the initial law, that accounts for the image that does not fit in. The computer readable medium may further include a storing source code segment that stores legal reasoning data, the data comprising the objective, the initial law, the image that does not fit in and the second law. The stored data is accessible by multiple users through a data network.

The presenting source code segment may further present a second image that does not fit in with the objective as indicated by the second law. The receiving source code segment then receives a third law, derived from the second law, that accounts for the second image that does not fit in.

Yet another aspect of the present invention provides a system for analyzing legal reasoning for determining a law, including a central processing unit that runs a computer program for the legal reasoning analysis and a server connected to the central processing unit. The server is accessible by multiple user terminals through a packet switched data network. The central processing unit presents an objective of the law to the user terminals by way of the server and receives an initial law relating to the legislative objective. The central processing unit receives a proposed image that does not fit in with the objective, as indicated by the initial law, and presents the proposed image that does not fit in to the user terminals by way of the server. The central processing unit then receives votes from the user terminals and, based on the votes, determines whether a predetermined number of the participants agree that the proposed image that does not fit in is an actual image that does not fit in with the objective, as indicated by the initial law. When the central processing unit determines that a majority of the participants agree that the proposed image that does not fit in is the actual image that does not fit, the central processing unit receives a second law, derived from the initial law, that addresses the actual image that does not fit in. The system may further include a memory data base, connected to the central processing unit, which stores data related to the legal reasoning analysis. The stored data includes the objective, the initial law, the actual image that does not fit in, the second law and the voting results.

Another aspect of the present invention provides a method for analyzing legal reasoning for deriving a final law. The method includes determining an objective of the final law, determining an initial law corresponding to the objective and consecutively presenting scenarios that potentially obstruct the objective. For each of the scenarios that potentially obstructs the objective, consecutively determine corresponding revised laws that remove the potential obstructions. A last revised law of the consecutively determined revised laws is identified as the final law. The method may further include receiving voting results regarding whether each one of the proposed scenarios includes one of the scenarios that potentially obstructs the objective.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts through several views of the drawings, and in which:

FIG. 1 is a block diagram illustrating an exemplary structure of the legal decision making device for implementing the legal decision making methodology, according to an aspect of the present invention;

FIG. 2 is a block diagram illustrating an exemplary system for accessing the legal decision making device via the Internet, according to an aspect of the present invention;

FIG. 3 depicts the basic unit of the legal reasoning analysis methodology, according to an aspect of the present invention;

FIG. 4 depicts the process of creating a legal map combining the basic units of the legal reasoning analysis methodology, according to an aspect of the present invention;

FIG. 5 depicts an example of a legal map created by the legal reasoning analysis methodology, according to an aspect of the present invention;

FIG. 6 depicts an example of a “thread” indicated in the legal map, according to an aspect of the present invention;

FIG. 7 depicts an example of the x, y and z axes indicated in the legal map, according to an aspect of the present invention;

FIG. 8 depicts an example of addressing based on the x, y and z axes indicated in the legal map, according to an aspect of the present invention;

FIG. 9 is a block diagram illustrating the relationship between positive laws and “virtual laws” or “marginal laws,” according to an aspect of the present invention;

FIG. 10 depicts exemplary results of an Internet voting system, according to an aspect of the present invention;

FIG. 11 depicts an exemplary application of the basic unit of the legal reasoning analysis methodology for creating the legal map, according to an aspect of the present invention;

FIG. 12 depicts an exemplary dialectic decision tree, , according to an aspect of the present invention;

FIG. 13 depicts an example of copying the legal reasoning analysis methodology to the legal map, according to an aspect of the present invention;

FIG. 14 is a block diagram illustrating the concept of tautology, according to an aspect of the present invention;

FIG. 15 depicts an example of the derivation of a law, according to an aspect of the present invention;

FIG. 16 is a block diagram illustrating the concept of tautology, according to an aspect of the present invention;

FIG. 17 depicts an example of a publicized database displayed at a graphical user interface, according to an aspect of the present invention; and

FIG. 18 depicts a decision tree diagram of economic analysis, according to the prior art.

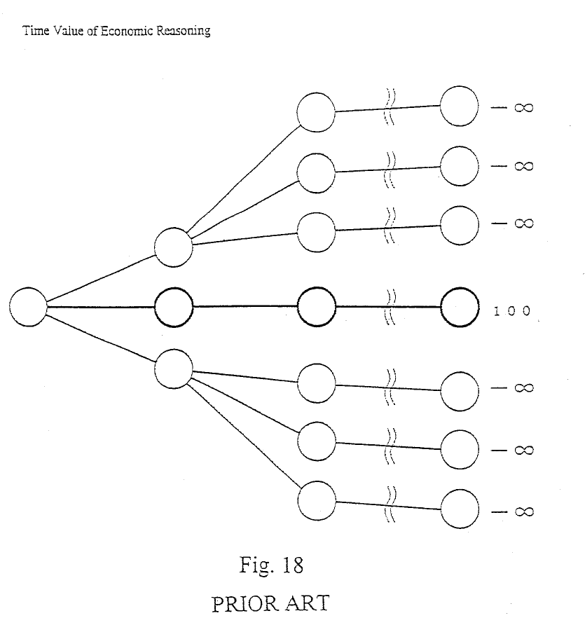

### DETAILED DESCRIPTION OF EMBODIMENTS

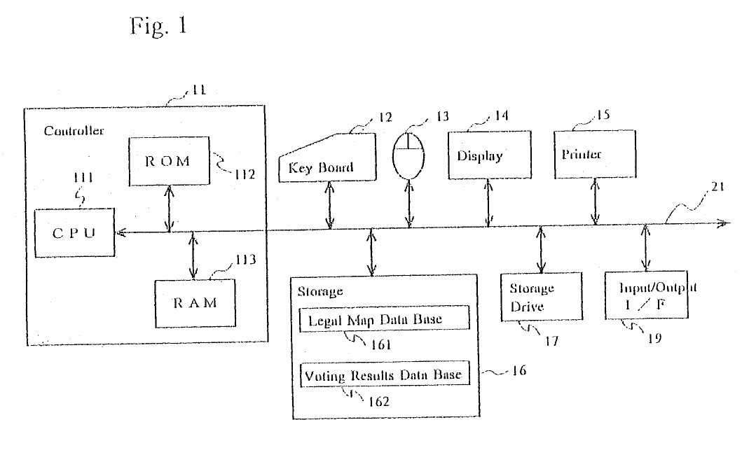

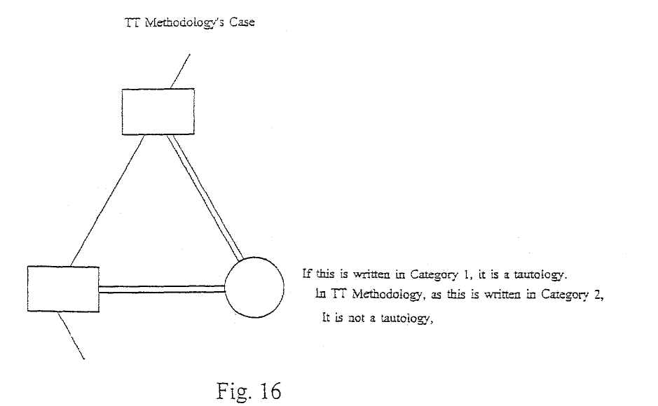

The description of the present invention refers to FIGS. 1-17. FIG. 1 is a block diagram illustrating an exemplary structure of the legal decision making device for implementing the legal reasoning analysis methodology. The legal decision making device involves any known computer system, including for example personal computers, word processors, and the like, capable of executing programming logic derived from the steps of the invention. The legal decision making device, as depicted in FIG. 1, includes a controller 11 to control the entire device. The controller 11 is connected via bus line 21 to typical interface and peripheral devices, including a keyboard 12 (including ten number keys), a mouse 13, a display 14, a printer 15, a memory 16, a storage medium drive 17 and an input/output interface 19. The controller 11 includes a central processing unit (CPU) 111, a read only memory (ROM) 112, and random access memory (RAM) 113. The ROM 112 contains various previously stored programs and data with which CPU 111 conducts various controls and calculations. RAM 113 is used by CPU 111 as a working memory.

The keyboard 12 may include Kana keys for inputting Japanese characters, ten keys for numbers, function keys for executing various functions, cursor keys and other conventional keys. In the alternative, characters in any language can be incorporated into the keyboard 12. The mouse 13 is a pointing input device to designate corresponding functions by left-clicking keys and icons displayed on the display 14. The display 14 may be a cathode ray tube (CRT) display, a liquid-crystal display, or other compatible graphical user interface. The display 14 may display a legal map screen to enable a user to input various proclaimed opinions as described herein. The printer 15 is for printing the legal map and any other information indicated on display 14. The printer 15 may be any conventional printer compatible with the controller 11, including laser printers, dot matrix printers, ink-jet printers, page printers, heat-sensitive printers, heat-transfer printers, and the like.

The memory 16 may include random access memories and drives for reading and writing various types of information, such as programs and data. The memory 16 may include any type of computer readable storage medium, including for example, hard discs. The storage medium drive 17 may likewise include random access memory. The memory 16 includes a legal map database 161 and an Internet voting results database 162. It also has other data storage not shown in FIG. 1, such as back-up storage for programs and data. The memory 16 may be adaptable to accommodate large amounts of data, depending on utilization requirements. The storage medium drive 17 is a drive for the CPU 111 for reading in computer programs and documents from external storage, including the memory 16. Stored computer programs include programs for various processes of the legal decision making device, as well as related dictionaries and data. Various storage media are incorporated, such as floppy discs, hard discs, magnetic storage media (e.g., magnetic tapes, memory chips), semiconductor storage mediums (e.g., IC cards) and optical storage mediums (e.g., CD-ROM). The storage medium drive 17 can read computer programs from the various storage media, and write data to be stored in the RAM 113 or the memory 16, or in rewrite-able storage media, such as floppy discs.

In the legal decision making device, the CPU 111 in the controller 11 reads computer programs from external storage medium(s) via the storage medium drive 17 and stores the programs in the memory 16, for example. The programs are then read from the memory 16 for execution by the RAM 113 and executed. Alternatively, the computer programs are not read from the memory 16, but are directly input from the external storage medium via the storage medium drive 17 into the RAM 113.

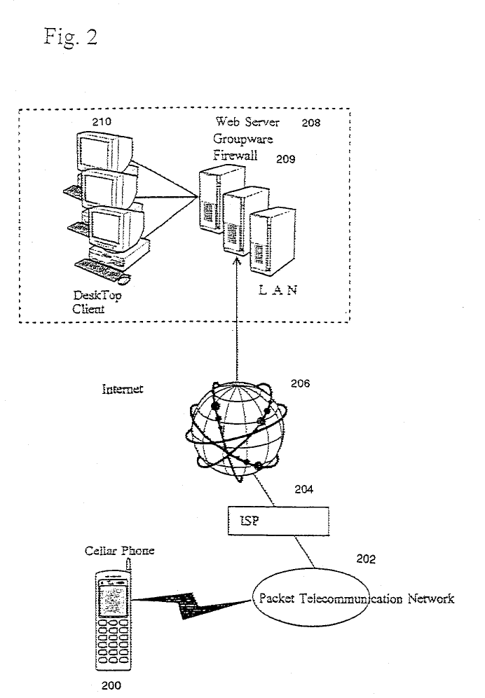

FIG. 2 is a block diagram illustrating an exemplary system in which the legal decision making device is operated on multiple computers interconnectable via a packet switched data network, such as the Internet. The system is accessible using any network compatible devices, including Internet compatible cellular phones, analog and digital modems and cable modems. In particular, FIG. 2 depicts an Internet compatible cellular phone 200, that accesses the Internet 206 via the packet switched data network 202, and the applicable Internet service provider 204. Once on the Internet, the cellular phone 200 is connected to a legal reasoning analysis web server 208, which may include a conventional firewall 209 and which runs groupware, such as Microsoft XP, developed by Microsoft Corporation, and Lotus Domino, developed by International Business Machines (IBM), for example, or other application software. The web server 208 communicates with a client 210, which may include a series of desktop computers. The client 210 includes the legal decision making device depicted, for example, in FIG. 1.

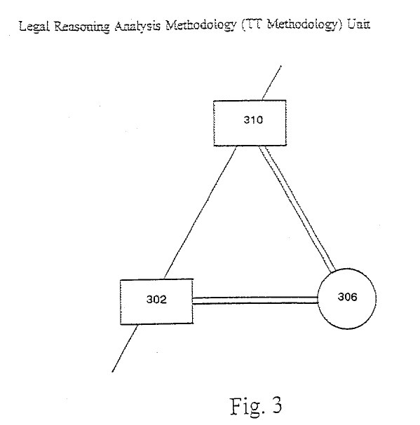

Next, a summary of the legal reasoning analysis methodology, as implemented by the legal decision making device, will be explained according to the present invention. The logic of the methodology is represented by triangular units, an example of which is shown in FIG. 3. As in the analogous cash flow analysis of the economic decision making process, a single legal decision can be represented as a composition of small, single-unit dialectic blocks or units. More in-depth legal decision making is enabled though analysis of each block, as well as analysis of a chain of connections or relationships among multiple blocks (e.g., a “thread”).

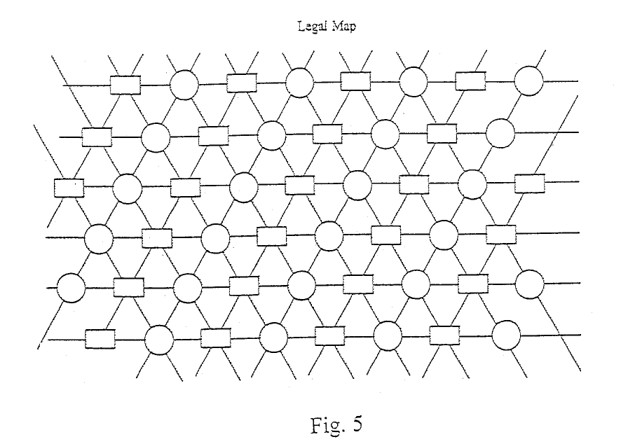

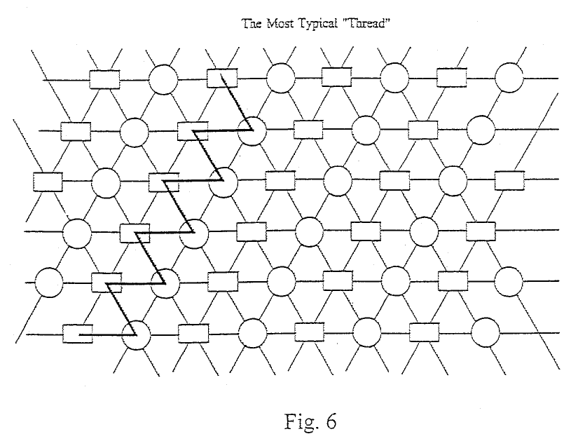

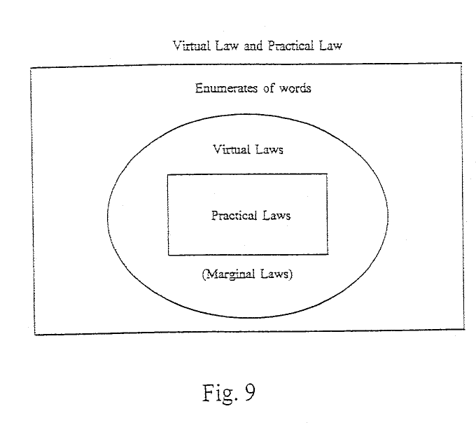

When considering the legal reasoning analysis methodology, a large overall legal system, referred to as “Virtual Laws,” or “Marginal Laws,” can be constructed from groups of words (e.g., the universe of words). Within the Virtual Laws is a subset of “Practical Laws,” as indicated by FIG. 9. The legal system can be depicted as a “legal map,” examples of which are shown in FIGS. 5-8. The components of the legal map include three directions of lines connecting rectangles and circles. The rectangles represent Virtual Laws and the circles represent unacceptable consequences of implementing a law, known as “nightmares” or “results that do not fit in.” The line or “thread” connecting a series of rectangles, which proceeds from the bottom left portion to upper right portion of FIG. 6, represents the “System of Laws.” The thread connecting a series of circles, which likewise proceeds from the bottom left portion to the upper right portion of FIG. 6, represents the “Composition of Nightmares.” The zigzagging bold line of FIG. 6 indicates a typical thread of reasoning according to an embodiment of the invention.

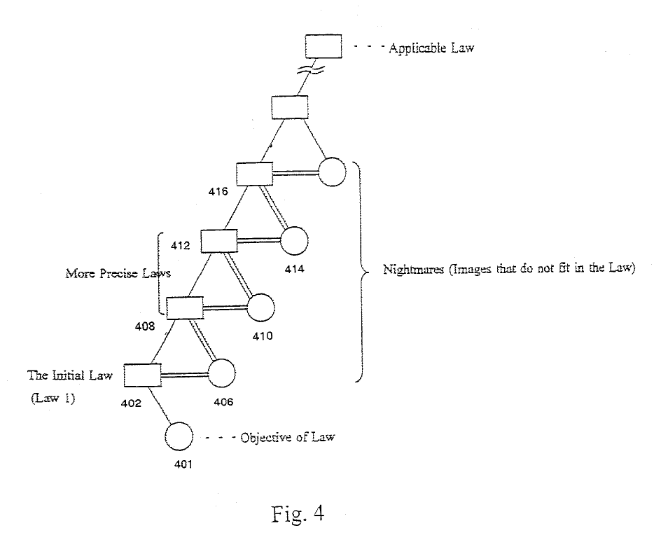

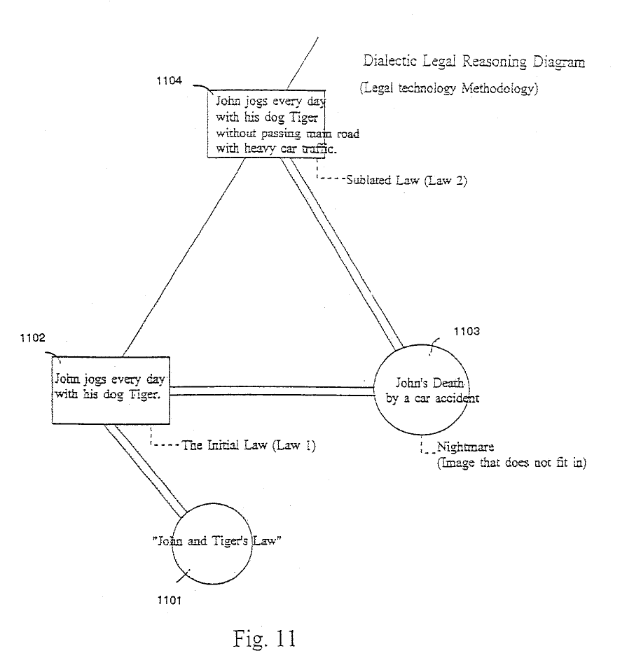

Implementation of the legal reasoning analysis methodology using a legal map is illustrated by the following example. Assume that John jogs with his family dog, Tiger. John is in charge of Tiger. John decides to create one rule for jogging, which is an example of a Virtual Law. The rule is depicted as “the initial law” at rectangular 402 of FIG. 4, as well as rectangle 1102 of FIG. 11. John establishes the initial law by consulting families, friends, teachers and neighbors. The objective of the law, indicated by circles 401 and 1101, is to govern “John and Tiger's jogging” in order to promote John's health. The initial law created by John is that “John jogs every day with his dog Tiger,” indicated by rectangle 402 of FIG. 4 and rectangle 1102 of FIG. 11.

John's initial law is subject to analysis by the affected community of John's family and friends. For example, John's mother adds, “We do not want John to be involved in an accident with a automobile.” John must therefore consider death or injury by automobile accident. In this case, John agrees that “John's death by automobile accident” is a nightmare (i.e., an image that does not fit in with the objective of the law as articulated by the initial law). This nightmare is indicated by circle 406 of FIG. 4 and circle 1103 of FIG. 11. Therefore, John revises his law to “John jogs every day with his dog Tiger, not passing any main roads with heavy automobile traffic.” The revised law is a more detailed or more precise law derived from the initial law. The revised law is indicated by rectangle 408 of FIG. 4 and rectangle 1104 of FIG. 11. The initial law, the nightmare, and the revised law form a triangle, as clearly shown in FIG. 11. One can easily see that the detailed law has been created with dialectic methodology reconciling the initial law and the nightmare. By illustrating the reasoning process with dialectic triangles, i.e., creating a legal map, the logic establishing each revised law is clearly recorded.

Next, assume that a neighbor says, “At night, there are strange people around, so John and Tiger had better not jog at night.” John must therefore consider death or injury from an attack by a stranger, which John agrees is a second nightmare, indicated by circle 410 of FIG. 4. John once again revises his law to “John jogs every morning with his dog Tiger, not passing any main roads with heavy automobile traffic.” This second revised law, indicated by rectangle 412, is more precise than the revised law of rectangle 408.

Next, John's father says, “It is dangerous to be outside during a typhoon.” John considers being killed or injured by a falling tree during a typhoon a third nightmare, indicated by circle 414. Therefore, John once again revises his law to “John jogs every morning with his dog Tiger, except for mornings during typhoons, not passing any main roads with heavy automobile traffic.” This third revised law is indicated by rectangle 416 of FIG. 4.

John's friend from school, Nancy, says, “You had better not pass by Mr. Kyte's house; he owns a vicious dog, Gon.” John considers Tiger's injury from attack by another dog, as well as his own potential severe injury. John determines that the worst case scenario is that Gon bites him and Tiger, but that it is unlikely that the resulting injury would be fatal. Furthermore, John wishes Tiger to be strong and unafraid of other dogs. Therefore, John and Tiger's injury by Gon is not deemed a nightmare. John therefore concludes that “John and Tiger do not pass by Mr. Kyte's house while jogging” should not be included in the law, either directly or indirectly, as discussed below.

John's teacher Elizabeth further advises, “You had better take a break from jogging on Saturday and Sunday.” John considers deterioration of his health due to excessive jogging. However, he determines that jogging every morning can improve his health, so that deterioration in health by excessive jogging is not a nightmare. Again, John concludes not to revise the law.

As a result of the reasoning explained above, John establishes the following result: John's Law: “John jogs every morning with his dog Tiger, except for mornings during typhoons, not passing any main roads with heavy automobile traffic.” The reasoning process is depicted by the bold line of FIG. 6.

Similarly, laws dealing with the crime of murder can be analyzed using the legal reasoning analysis methodology of the present invention. First, the objective of the law is determined, i.e., “punishment for the crime of murder.” Considering that in many cases, the murder suspects have actually committed the crime, the following initial law is established: “Those who kill people shall be punished by death.”

Next, if killers were permitted to live normal lives, without any punishment or threat of punishment, people would conclude that that they could do whatever they want, even commit murder, without penalty. In such a case, we consider “primitive competition” or “anarchy” as a nightmare. In response, we create the first revised law to address the nightmare: “Those who kill people without reason shall be punished by death.”

However, among those who kill are people who kill without the intention of killing. In such a case, we consider “putting people to death who have killed by accident” as a nightmare. So, to address the potential disastrous results posed by this nightmare, a more precise, second revised law is created: “Those who kill people with the intention of killing shall be punished by death.”

Furthermore, there are people who kill others using people as their murder tools. For example, hiring a professional assassin to kill another should not be tolerated even though the person who hired the assassin does not actually perform the act of killing. We consider “allowing people who kill by hiring others to do the killing to go unpunished” as a nightmare. The third revised law is therefore “Those who cause the killing of people with the intention of killing shall be punished by death.”

Furthermore, there are cases in which people kill another to protect themselves from being killed. In such case, we consider “putting people to death who have killed intentionally, but in self-defense,” as a nightmare. So, the more precise, fourth revised law is “Those who cause the killing of people with the intention of killing shall be punished by death, except for those who cause the killing of people to protect themselves from being killed.”

Moreover, it is obvious from a practical standpoint that it may not always be appropriate to punish by death everyone suspected of killing another. A person deemed to have killed another and accordingly punished by death, may later be determined not to have actually committed the crime. In such a case, there is no recovery or recourse for the accused. Therefore, we consider “a person punished by death for killing another is subsequently revealed not to have killed the person” as a nightmare, known as “a false accusation.” So, we refine the law to “Those who cause the killing of people with the intention of killing shall be punished by death or penal servitude, except for those who cause the killing of people to protect themselves from being killed.”

As in the foregoing examples, the legal reasoning analysis methodology functions sufficiently to clarify the reasoning to establish the laws. Importantly, even those who do not know technical legal terms or concepts (e.g., penal servitude, legitimate self-defense, the natural law, etc.) can follow the legal reasoning analysis methodology if they have a specific nightmare. Furthermore, once we clarify the thinking process with this methodology, in the case where a law needs to be revised because the situation changes, we are able to pick up the process at the point to be discussed. The legal reasoning analysis methodology provides the material for discussing how the legal reasoning should be extended or amplified to arrive at the more precise laws.

Next, the scope of Virtual Laws is explained. In the first example discussed above, (1) John's death by automobile accident, (2) John's death or wounding by a stranger, and (3) John's injury by a falling tree are nightmares (i.e., images or situations that are inconsistent with the objective of the law as represented by the existing laws). This is because John concluded that these scenarios represented infinitely negative payoffs. In this sense, the “Law regarding John and Tiger” is very subjective, applicable only to John. In contrast, if John's friend Ben thinks that John's mere wounding by a stranger does not represent an infinitely negative payoff, the scope and application of the “Law regarding John and Tiger” to such an alternative world (i.e., group), such as “Friends,” “Society” or “School, ” as opposed to “John and his Family,” is arguable once again.

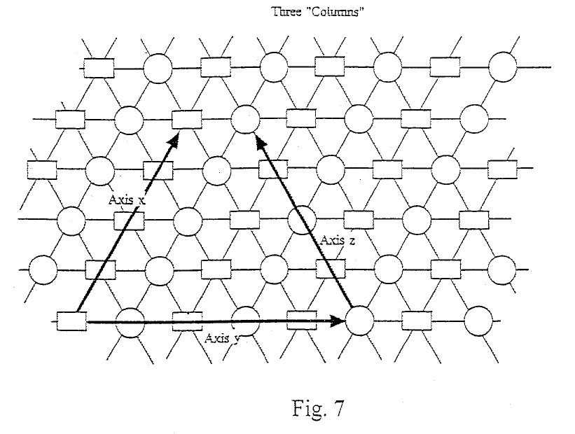

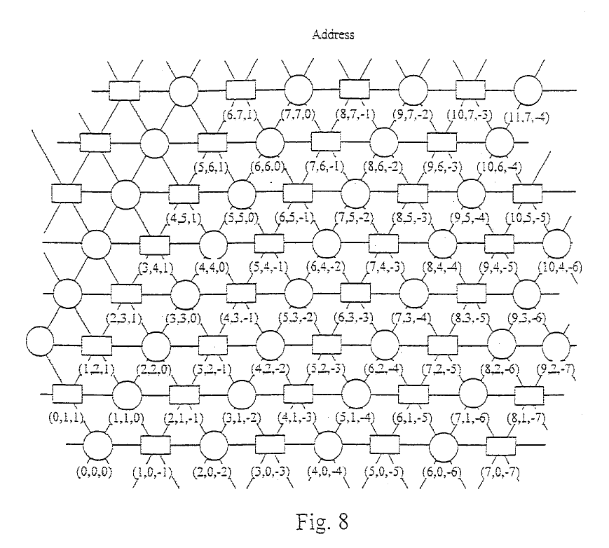

FIGS. 5 and 8 depict exemplary legal maps according to an aspect of the present invention. A legal map includes a series of three sets of intersecting lines: diagonal lines from bottom left to upper right, horizontal lines from left to right, and diagonal lines from bottom right to upper left. The three sets of lines respectively correspond to the x, y and z axes of the legal map, as shown in FIG. 7 and described in detail below. Each intersection among three lines in each set is represented by a respective coordinate, such as a, b and c, so that each position on the legal map may be identified in terms of the three intersecting lines (a, b, c). If the coordinate c (representing the diagonal line from bottom right to upper left) is an even number, the corresponding position on the legal map is represented by a circle. If the coordinate c is an odd number, the corresponding position on the legal map is represented by a rectangle. FIG. 8 depicts the series of intersecting lines and the addresses and shapes associated with each intersection.

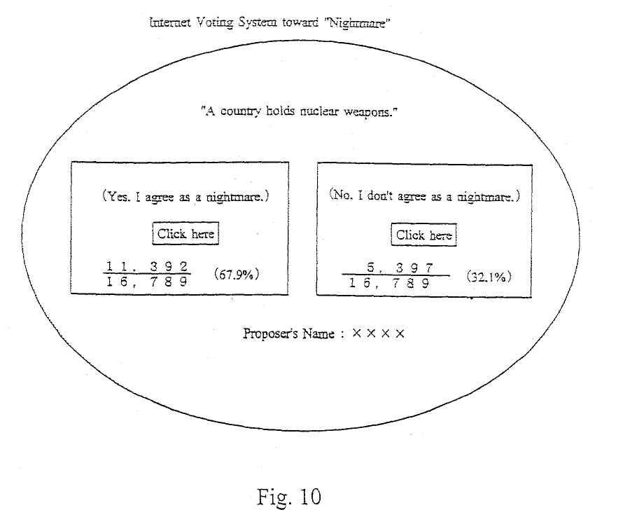

FIG. 10 depicts an example of the Internet voting system display for “Nightmares,” according to another aspect of the present invention. The Internet voting system enables people to participate via a data network, such as the Internet, and to vote on whether a proposed scenario represented on the legal map constitutes a nightmare (i.e., an image or situation inconsistent with the objective of the existing law), using a one click voting system. The legal map is stored, for example, in the legal map database 161 of FIG. 1, which is accessible via the Internet. The Internet voting system enables a participant to click either “I agree that a particular image or situation is a nightmare” or “I don't agree that a particular image or situation is a nightmare,” displayed on each participant's computer display 14. In alternative embodiments, the voting options may be displayed on any Internet compatible graphical user interface, including, for example, a screen of a cellular phone.

FIG. 10 depicts an example in which the participants vote on whether the statement, “a country holds nuclear weapons” constitutes a nightmare with respect to an objective of maintaining world peace. In this example, 11,392 out of 16,789 participants (67.9%) agree that the statement is a nightmare, while 5,397 out of 16,789 participants (32.1%) do not agree that the statement is a nightmare. The voting results are accessible to the public in a database.

The Internet voting system is not a voting system that judges a proposal by majority logic. This characteristic is different from an existing voting system. The voting results are shown in the form of a denominator (i.e., the number of total votes), a numerator (i.e., the number of votes for yes/no), and the corresponding percentage points (i.e., the number of votes for yes/no divided by the number of total votes). In an embodiment of the invention, visitors to the Internet voting system web site can familiarize themselves with the contents of the Composition of Nightmares and the respective levels of agreeability.

Using the Internet voting system, the participants can share the consideration for the degree and scope of each nightmare's agreeability, which is a component of the Composition of Nightmares. The voting results are disclosed via the Internet regarding the shared nightmares in the field of “virtual” or “marginal” field of laws. Conventionally, this field (or discussion) is processed by election, majority logic or talk among individuals. The disclosed system is a basis for discussion of virtual or marginal laws, which will subsequently evolve into practical laws. Practical laws are the pragmatic laws developed and enforced by governments, such as criminal codes, commercial codes, and other legislation. In other words, the voting results over the Internet are an original form of future laws or virtual laws.

Next, the legal decision making device will be explained regarding the implementation of the third objective of this invention, i.e., providing a computer program to execute the legal reasoning analysis methodology. The legal decision making device sets the legal reasoning analysis methodology as a premise. We therefore explain the legal decision making device using the example illustrating the first objective of the invention.

FIG. 11 depicts category 1 and category 2 expressions. The category 1 expressions are practical and are described in words, sentences, paragraphs, etc., and symbolized in FIG. 11 by rectangles. The category 2 expressions are conceptual and are described in terms of images, dreams, nightmares, etc., and are symbolized by circles. If the Objective of the Law is written in category 2 form, it is an “Objective of the Law” or “Legislative Objective.” In FIG. 11, for example, the circle 1101 at the bottom represents the Objective of the Law written in category 2 form. Applying the previous example, the Objective of the Law is to govern John and Tiger's jogging in order to promote John's health. When the Objective of the Law is written in words, i.e., written in category 1 form, it becomes “John jogs every day with his dog Tiger.” This statement, which follows from the Objective of the Law, is the initial law or Law 1, located in the rectangle 1102 of FIG. 11.

Next, we imagine a totally destructive disaster when this law is applied. The disaster is called “a nightmare towards the law” or “an image that does not fit in with the Law.” The nightmare is written in category 2 form: “John's death by a automobile accident,” as indicated in the circle 1103. In response to the imagined nightmare, the second law, or Law 2, is derived: “John jogs every day with his dog Tiger, not passing any main roads with heavy automobile traffic,” as indicated in the rectangle 1104. The derivation of the second law of rectangle 1104 from the initial law of the rectangle 1102 is one unit of dialectic legal reasoning. The dialectic legal reasoning cycle is repeated over and over until a law ultimately established is at the stage that no additional nightmares in application of the law are contemplated. This is the course or process of legal reasoning.

In this legal reasoning process, it is important how we consider and judge the nightmares, i.e., determining the “Composition of Nightmares.” The Composition of Nightmares totally or significantly affects the output of the legal reasoning process and the scope of the established laws. The perception of the nightmares is unique to the individual in terms of establishing laws.

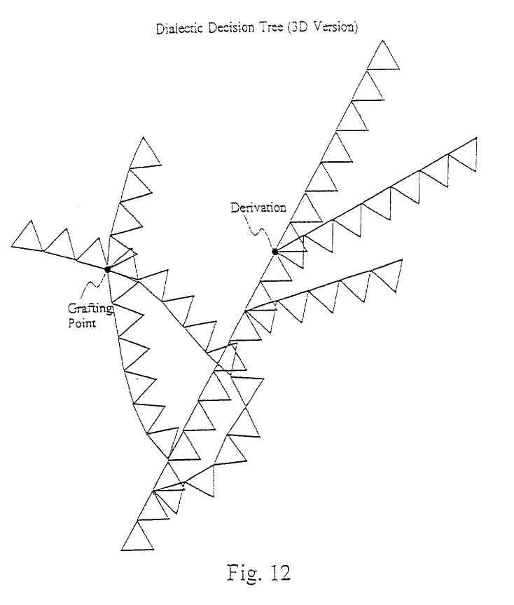

Next, a dialectic decision tree will be explained referring to FIG. 12, based on the dialectic legal reasoning, described above. The decision tree diagram has basically a 3-dimensional structure. However, as discussed below, the 3-dimenisional structure can be translated into 2-dimensional chart. FIG. 12 represents a 3-dimensional example.

The 3-dimensional dialectic decision tree diagram can be expressed as a growing plant in terms of structure. Each of the triangles shown in FIG. 12 is one unit of dialectic legal reasoning, as shown, for example, in FIG. 3. From a ramification, or separation of branches, the legal reasoning process expands and grows as shown in FIG. 12.

FIG. 12 depicts two types of expansion within the legal reasoning process, a “derivation” and a “grafting point.” A derivation means that, based on the same initial law as a premise, we arrive at different, more precise laws because the perceived nightmares are different. Laws may derive from any previously stated law, i.e., any rectangle on the legal map, in the dialectic legal reasoning process. In FIG. 12, derivations are expressed as branches extending from connecting points of two triangles. A grafting point is the point at which two established laws have the same scope and value, even though the routes followed to establish each of the laws, i.e., the respective Compositions of Nightmares, are different. Whether a point is a grafting point is judged by those who conduct the legal reasoning process. As corroboration, tautology can indicate whether a point is a grafting point, as described below.

From a scientific standpoint, the dialectic decision tree diagram is a kind of fractal that self-recurs (e.g., a self-replicating structure). Wherever a branch is cut off, there is a branch group that begins from the cutoff point. The dialectic decision tree diagram shows one law system. Ideally, by replicating the branch group algorithm, one database of a law system is created. Therefore, we explain how to translate the 3-dimensional dialectic decision tree diagram into a 2-dimensional dialectic diagram, or a 2-dimensional legal map, and how to address the legal map.

First, we explain how to address the legal map. As shown in FIG. 8, the origin point of the legal map is (0,0,0), which corresponds to an objective of the law written in category 2 form. As discussed above, the thread that stretches from the bottom left to the upper right of FIG. 8 is the x axis; the thread that stretches from left to right is the y axis; and the thread that stretches the bottom right to the upper left is the z axis (shown in FIG. 7). Therefore, the coordinates (a, b, c) define points on the x, y and z axes, respectively. Each address is indicated in this manner. For example, the Initial Law or Law 1 is (0,1,1); Nightmare 1 is (1, 1, 0); Law 2 is (1, 2, 1); etc. When a coordinate of the z axis is an even number, the location is a circle (i.e., a category 2 location). When a coordinate of the z axis is an odd number, the location is a rectangle (i.e., a category 1 location).

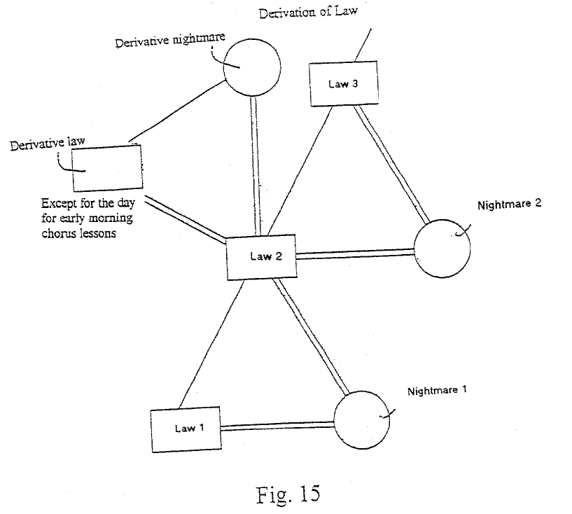

Next, the algorithm of translation from the 3-dimensional dialectic decision tree diagram to the legal map is presented, based on an example of a derivation point using an extended version of “John and Tiger's Law.” At the time John determines the first revised law, “John jogs every day with his dog Tiger, not passing any main roads with heavy automobile traffic,” his friend Kathleen says to him, “You have been elected to be a member of a chorus group, which has lessons in the early morning.” John confirms this fact with the chorus teacher, who says that it is true. John therefore considers whether he should get up 30 minutes earlier, e.g., at 5:30 a.m., to jog with Tiger. However, he imagines the following nightmare: “John's health deteriorates due to insufficient sleep.” The nature of this nightmare is differs from the previously considered nightmares, all of which focused on physical injury and death to John and Tiger, as opposed to passive deterioration of John's health. John therefore establishes Derivative Law 1: “John jogs every day with his dog Tiger, not passing any main roads with heavy automobile traffic, except he does not jog on the day he has a chorus lesson in the early morning at school.” Derivative Law 1 is the law derived from Law 2 as shown in FIG. 15. In particular, John contemplates two nightmares related to Law 2, i.e., the first revised law, which results in two branches of evolving legal analysis.

The algorithm that represents the reasoning described above is basically the dialectic legal reasoning algorithm, represented as a 3-dimensional dialectic decision tree, as shown in FIG. 12. The 3-dimensional dialectic decision tree diagram is translated into a 2-dimensional legal map as follows:

(1) If the perceived nightmare indicates a derivation of law in the legal system, find the first empty circle on the y axis to the right of the law (or rectangle) subject to derivation;

(2) find the remaining point of an equilateral triangle using the first empty circle as the bottom, right corner and the law subject to derivation as the bottom left corner;

(3) if the determined remaining point is an occupied rectangle (i.e., it already contains a revised law evolving from the law subject to derivation), return to step (1) using the next empty circle to the right of the first empty circle along the y axis;

(4) if the determined remaining point is an empty rectangle, describe a derivative law addressing the nightmare; and

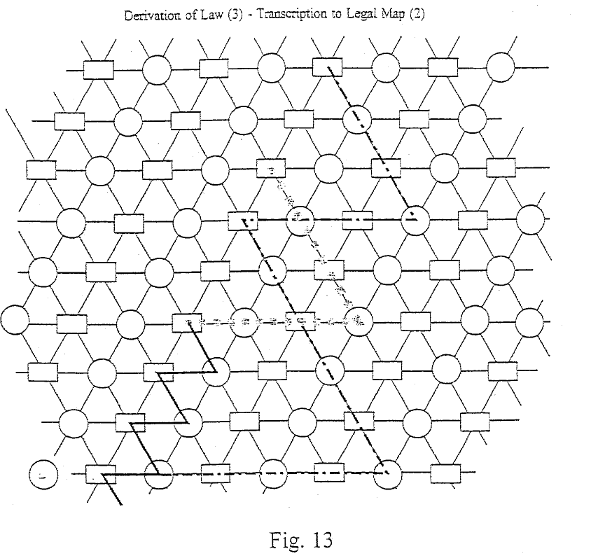

(5) return to step (1) using the newly described derivative law until no more nightmares are imagined, resulting in one legal system being mapped on one single line. An expanded example of branching to accommodate derivative laws is shown in FIG. 13, indicating a legal map derived from a dialectic decision tree diagram. The solid zigzagging line of FIG. 13 indicates the one legal system evolving from the law subject to derivation. The dashed zigzagging line indicates the branched legal system derived from the same law subject to derivation.

A computer program creating the type of legal map, described above, may be provided to clients via the Internet or in the form of CD-ROMs, as “Legal Technology Kits,” for example. In an embodiment, the computer program may be implemented on an IBM Pentium based personal computer, running the Microsoft Windows, Linux or UNIX operating systems, for example. Alternatively, the computer program may be used as an educational tool for children to nurture and exercise their legal decision-making abilities.

The meaning of “tautology” is now explained, as used with respect to in the present invention. Usually, tautology is defined as an unnecessary repeating of the same idea in different words, where the logic comes to a dead end. However, tautology, as used with respect to the present invention, is defined as a theorem that supports evidence of the integrity of the logic. For example, as applied to “John and Tiger's Law,” tautology is implemented as follows:

The first presupposition (A)—“John jogs every day with his dog Tiger.”

The second presupposition (B)—“John is jogging avoiding his death from a automobile accident,” which is the negation of a nightmare.

The conclusion (C)—“John jogs every day with his dog Tiger, not passing any main roads with heavy automobile traffic.”

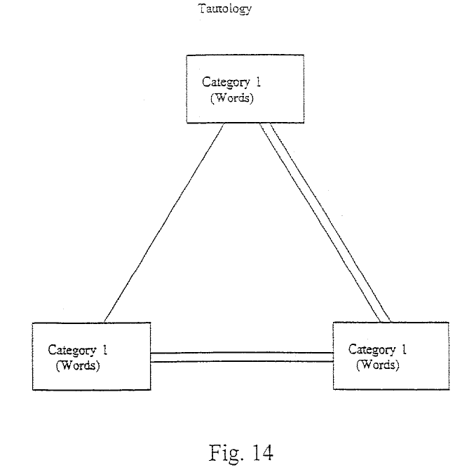

If the statements (A), (B) and (C) are expressed in words, i.e., category 1 form, they become a tautology. In actuality, though, statement (B) can not be expressed in words, which means it is in category 2 form, and functions merely as a driver for discussion. As a result, the discussion evolves. If statement (B) were translated from category 2 form to category 1 form, the result would be a tautology, confirming the integrity of the logic forming the triangle, as shown in FIG. 14. The tautology is evidence that the logic is not a leap (i.e., a logical gap) or a digression.

Next, the time value of the legal reasoning process is explained. In a typical decision tree diagram, for a branch having a final payoff of infinitely negative, the expected value of its branch is infinitely negative, even though its probability is “any,” i.e., ∞ * (any probability)=∞. Accordingly, the payoffs of these branches are always infinitely negative, regardless of the span of time from the beginning of the scenario to the termination of the scenario. We can therefore ignore the time value of any branch with infinitely negative payoff. Legal decision making is a fiction of decision-making to choose one possible branch having a finite payoff (the other branches' payoffs having infinitely negative payoffs). Therefore, when the payoff is infinitely negative, the scenario analysis, or the time value of money (payoff), between establishment of the law and the occurrence of the nightmare can be ignored.

Next, the open source database of the legal decision making process, with respect to implementation of the fourth objective of the present invention, is explained. Based on the above implementation example, an open source database is created that is accessible on-line over the Internet to be shared by people. Each participant's legal reasoning can be transferred to and stored in the database using the legal reasoning analysis methodology, i.e., a dialectic block and a decision-making unit as components of more complicated legal decision-making. The database is a base of knowledge management.

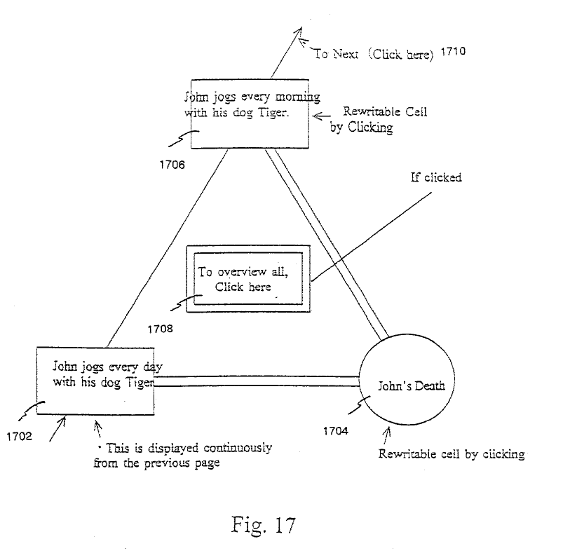

FIG. 17 depicts an example of a web screen depicting information stored in the open source database. Each dialectic block is displayed at the participant's graphical user interface. The first revised law, or Law 1, is displayed in block 1702, the first contemplated nightmare is displayed in circle 1704 and the second derived law, or Law 2, is displayed in block 1706. By clicking in the circle 1704, the participant is able to rewrite the nightmare. Likewise, by clicking in the block 1706, the participant is able to rewrite the second revised law designed to account for the nightmare of circle 1704. To move to the next set of three dialectic blocks in the series, the participant clicks on the arrow 1710 at the top of the displayed triangle. By clicking on the center button 1708, the whole structure (e.g., a legal map, including the “thread,” as indicted in FIG. 6) can be viewed. By proceeding in this system, a virtual body of laws of the people, by the people and for the people is established in real terms. The participants are able to share and publicize their ideas, as well as propose, discuss and analyze their nightmares. Also, because the system may be global, every people all over the world can access the database from everywhere in the world. In this sense, the present invention is usable as a worldwide database.

As described above, the present invention has numerous positive effects. For example, the present invention enables clarification of the specific thinking and legal reasoning process for establishing a certain law in light of an associated legislative objective for establishing the law. Following this process enables the creation of a more appropriate law, which is adaptable to reality and minimizes legislative defects. The legal reasoning process can be represented by a triangle diagram, or a series of integrated triangle diagrams, that enable visualization of the process. At a glance, the observer is able to grasp clearly the thinking procedure behind the legislation. The process may be implemented by computer.

Furthermore, the process can be opened to the public at large, or to a representative segment of the population, to receive input regarding various scenarios that may obstruct the legislative objective. Also, the process may include voting results to determine whether the various scenarios are significant enough with respect to the legislative objective to warrant consideration in determining the final law. For example, an Internet voting system may accommodate this interaction with the public for future law legislation. The voting results would likewise be available to the public.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its various aspects. Although the invention has been described with reference to particular embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same or better functions. Accordingly, replacement standards and protocols having the same functions are considered equivalents.

The present disclosure relates to subject matter contained in priority Japanese Patent Application No. 2001-136201, filed on May 7, 2001, the contents of which is herein expressly incorporated by reference in its entirety.

What is claimed:

1. A method for analyzing legal reasoning for determining a law, the method comprising:
presenting a legislative objective of the law via a computer network;
determining an initial law corresponding to the legislative objective;
presenting an initial image that does not fit in with the initial law via the computer network, potentially obstructing the legislative objective; and
determining a second law by revising the initial law to remove the potential obstruction caused by the initial image that does not fit in with the initial law.

2. The method for analyzing legal reasoning according to claim 1, further comprising:
presenting the second law via the computer network.

3. The method for analyzing legal reasoning according to claim 2, the presenting the image that does not fit in comprising:
presenting a proposed image that does not fit in via the computer network, the computer network being accessible by a plurality of participants;
receiving votes on whether the proposed image that does not fit in obstructs the legislative objective; and
presenting the proposed image that does not fit in as the initial image that does not fit in when the voting determines that a majority of the plurality of participants agree that the proposed image that does not fit in obstructs the legislative objective.

4. The method for analyzing legal reasoning according to claim 3, further comprising:
displaying, substantially simultaneously via the computer network, at least a percentage of the plurality of participants that agree that the proposed image that does not fit obstructs the legislative objective.

5. The method for analyzing legal reasoning according claim 1, further comprising:
presenting a second image that does not fit in with at least one of the initial law and the second law, potentially obstructing the legislative objective; and
determining a third law by revising the second law to remove the potential obstruction of the second image that does not fit in with the at least one of the initial law and the second law.

6. A method for creating a legal map depicting legal reasoning for determining a law, the method comprising:
presenting an objective of the law;
determining an initial law to represent the objective and depicting the initial law at a first position of a triangle;
presenting an image that does not fit in with the objective, as represented by the initial law, and depicting the image that does not fit in at a second position of the triangle; and
deriving a second law that addresses the image that does not fit in with the objective and depicting the second law at a third position of the triangle.

7. The method for creating a legal map depicting legal reasoning according to claim 6, further comprising:
depicting the second law at a first position of a second triangle
presenting a second image that does not fit in with the objective, as represented by the second law, and depicting the second image that does not fit in at a second position of the second triangle; and
deriving a third law that addresses the second image that does not fit in with the objective and depicting the third law at a third position of the second triangle.

8. A computer readable medium for storing a computer program that enables analysis of legal reasoning to derive a law relating to an objective, the computer readable medium comprising:
a receiving source code segment that receives the objective of the law and an initial law proposed to achieve the objective; and
a presenting source code segment that presents an image that does not fit in with the objective as indicated by the initial law;
the receiving source code segment receiving a second law, derived from the initial law, that accounts for the image that does not fit in.

9. The computer readable medium for storing a computer program according to claim 8, further comprising:
a storing source code segment that stores legal reasoning data, the data comprising the objective, the initial law, the image that does not fit in and the second law, the data being accessible by a plurality of users via a data network.

10. The computer readable medium for storing a computer program according to claim 8, the presenting source code segment further presenting a second image that does not fit in with the objective as indicated by the second law; and
the receiving source code segment receiving a third law, derived from the second law, that accounts for the second image that does not fit in.

11. A system for analyzing legal reasoning for determining a law, the system comprising:
a central processing unit that runs a computer program for the legal reasoning analysis; and
a server connected to the central processing unit, the server being accessible by a plurality of user terminals via a packet switched data network;
the central processing unit presenting an objective of the law to the plurality of user terminals via the server and receiving an initial law relating to the legislative objective;
the central processing unit receiving a proposed image that does not fit in with the objective, as indicated by the initial law, and presenting the proposed image that does not fit in to the plurality of user terminals via the server;
the central processing unit receiving votes from the plurality of user terminals and, based on the votes, determining whether a predetermined number of the plurality of participants agree that the proposed image that does not fit in comprises an actual image that does not fit in with the objective, as indicated by the initial law; and
when the central processing unit determines that a majority of the plurality of participants agree that the proposed image that does not fit in comprises the actual image that does not fit, the central processing unit receiving a second law, derived from the initial law, that addresses the actual image that does not fit in.

12. The system for analyzing legal reasoning for determining a law according to claim 11, further comprising a memory data base connected to the central processing unit, the memory data base storing data related to the legal reasoning analysis, the stored data comprising the objective, the initial law, the actual image that does not fit in, the second law and the voting results.

13. A method for analyzing legal reasoning for deriving a final law, the method comprising:
determining an objective of the final law;
determining an initial law corresponding to the objective;
consecutively presenting a plurality of scenarios that potentially obstruct the objective;
for each of the plurality of scenarios that potentially obstructs the objective, consecutively determining a corresponding plurality of revised laws that remove the potential obstructions; and
identifying a last revised law of the consecutively determined plurality of revised laws as the final law.

14. The method for analyzing legal reasoning for deriving a final law, according to claim 13, further comprising:
receiving voting results regarding whether each one of a plurality of proposed scenarios comprises one of the plurality of scenarios that potentially obstruct the objective.
